(19) United States
(12) Patent Application Publication
(10) Pub. No.: US 2018/0107206 A1
(43) Pub. Date: Apr. 19, 2018

(54) DEVICE THAT ASSISTS A MANEUVERING PROCEDURE OF A MOTOR VEHICLE

(71) Applicant: FORD GLOBAL TECHNOLOGIES, LLC, Dearborn, MI (US)

(72) Inventors: Lars KUHNERT, Cologne (DE); Nadja WYSIETZKI, Cologne (DE); Georg NEUGEBAUER, Herzogenrath (DE); Ahmed BENMIMOUN, Aachen (DE)

(73) Assignee: FORD GLOBAL TECHNOLOGIES, LLC, Dearborn, MI (US)

(21) Appl. No.: 15/785,527

(22) Filed: Oct. 17, 2017

(30) Foreign Application Priority Data
Oct. 19, 2016 (DE) 10 2016 220 448.3

(51) Int. Cl. G05D 1/00; G01C 21/18

(52) U.S. Cl. CPC G05D 1/0016; G01C 21/18

(57) ABSTRACT

The disclosure relates to a device that assists a maneuvering procedure of a motor vehicle. The device comprises an operator control unit, and is configured to bring about a continuation of the maneuvering procedure only for as long as a predetermined actuation of the operator control unit is performed by an operator who is monitoring the maneuvering procedure. The operator control unit includes a plurality of inertial sensors. A continuation of the maneuvering procedure is brought about on the basis of sensor signals of said inertial sensors.

### CROSS-REFERENCE TO RELATED APPLICATIONS

This application claims foreign priority benefits under 35 U.S.C. § 119(a)-(d) to DE Application 10 2016 220 448.3 filed Oct. 19, 2016, which is hereby incorporated by reference in its entirety.

### TECHNICAL FIELD

The disclosure relates to a device that assists a maneuvering procedure of a motor vehicle.

### BACKGROUND

Remote controlled parking is a parking function that assumes control of the steering, gear shifting, accelerating and braking of the vehicle when the vehicle carries out a parking maneuver into a parking space or a garage, or carries out the corresponding exiting maneuver. The driver controls this function using an intelligent remote-control device (SRD=“Smart Remote Device”) from a location that is outside the vehicle. One required feature of this function is that it is necessary for the driver to confirm that he is paying continuous close attention to the parking maneuver. In order to fulfill this requirement and to verify the continuous attention of the driver, it is known to use a dead man's switch (DMS).

FIG. 4 illustrates a flow diagram for explaining this known concept. After the start of the maneuver (step S11), as in, for example, entering or exiting a parking space or garage, in step S12 a query is made as to whether the dead man's switch has been actuated. If this is the case, in step S14 the maneuver in question is continued, after. which. in step 15. a query is made as to whether the end position of the maneuver has been reached. The query in accordance with step S12 is repeated for as long as this has not occurred. After the end position has been reached, the maneuver is terminated (step S16). However, if the result of the query in step S12 with regards to the actuation of the dead man's switch is negative, the maneuver is immediately interrupted (step S13).

DE 10 2012 007 984 A1 discloses inter alia a maneuvering system and a method for automatically maneuvering a motor vehicle, wherein a portable communications device in the form of, for example, a smart phone is used as an operating device that controls the automatic maneuvering procedure. The automatic maneuvering procedure here is, for example, immediately interrupted if an operator is no longer touching a specifically-characterized switching region of the display of the communications device.

US 2015/0375741 A1 discloses inter alia a vehicle control system, a control unit being provided, which it is possible to cause the drive system of the vehicle to adjust the parking position of the vehicle in reaction to receiving a command signal from a mobile communications device. Moreover, the control device is configured to prevent adjustment of the parking position if a time span that has elapsed since the termination of a parking maneuver reaches a predetermined value prior to the command signal being received.

### SUMMARY

The object of the present disclosure is to provide a device that assists a maneuvering procedure of a motor vehicle. The device makes it possible, in a simple implementation, to reliably monitor continuous attention of the operator who is monitoring the maneuvering procedure.

A device in accordance with the disclosure that assists a maneuvering procedure of a motor vehicle comprises an operator control unit, and is configured to bring about a continuation of a maneuvering procedure only for as long as a predetermined actuation of the operator control unit is performed by an operator who is monitoring the maneuvering procedure.

The device is characterized by the fact that the operator control unit comprises a plurality of inertial sensors. A continuation of a maneuvering procedure is brought about based on sensor signals of the inertial sensors.

In particular, the disclosure implements a dead man's switch for use in a remote-controlled maneuvering procedure or a remote-controlled parking maneuver when using an operator control unit having integrated inertial sensors.

In accordance with one embodiment, the inertial sensors make it possible to determine a position of the operator control unit in six degrees of freedom.

In accordance with one embodiment, the device is configured to determine a spatial orientation of the operator control unit on the basis of the sensor signals of the inertial sensors.

In accordance with one embodiment, a continuation of a maneuvering procedure is enabled on the basis of a change in spatial orientation of the operator control unit.

In accordance with one embodiment, the plurality of inertial sensors comprises at least one acceleration sensor, at least one gyroscope and/or at least one magnetometer.

In accordance with one embodiment, in at least one operating mode, a continuation of the maneuvering procedure is brought about only as long as a continuous change in the spatial orientation of the operator control unit is determined. Consequently, in this operating mode a continuous change in the spatial orientation of the operator control unit is required (for example by implementing a rotational movement) in order to indicate that the driver wishes to continue a current maneuvering procedure or parking maneuver. As soon as the continuous change in the spatial orientation fails to occur, this is interpreted as “releasing a dead man's switch”, which leads to the maneuver being aborted.

In accordance with one embodiment, in at least one operating mode, a continuation of the maneuvering procedure is brought about only for as long as the spatial orientation of the operator control unit remains constant. In this operating mode, it is consequently necessary to maintain a constant spatial orientation of the operator control unit, whereby an indication is provided that the driver wishes to continue the current maneuvering procedure or parking maneuver. As soon as the continuous change in the spatial orientation is interrupted, this is interpreted as “releasing a dead man's switch”, which in turn leads to the maneuver or parking procedure being aborted.

In accordance with one embodiment, in at least one operating mode, a continuation of the maneuvering procedure is brought about only for as long as a continuous shaking movement of the operator control unit is detected. In this operating mode, accordingly, a shaking movement or wobbling movement of the operator control unit is required in order to indicate that the driver wishes to continue with the current maneuvering procedure or parking maneuver. As soon as the continuous shaking or wobbling of the operator control unit stops, this is interpreted as “releasing a dead man's switch”, which in turn leads to the maneuvering procedure being aborted.

The disclosure is further explained hereinunder using the preferred embodiments and with reference to the attached drawings.

### BRIEF DESCRIPTION OF THE DRAWINGS

FIG. 1 illustrates a diagram that explains operation of a device in accordance with the disclosure in a first operating mode,

FIG. 2 illustrates a diagram that explains operation of a device in accordance with the disclosure in a second operating mode,

FIG. 3 illustrates a diagram that explains operation of a device in accordance with the disclosure in a third operating mode, and

FIG. 4 illustrates a diagram that explains the known principle of a dead man's switch.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

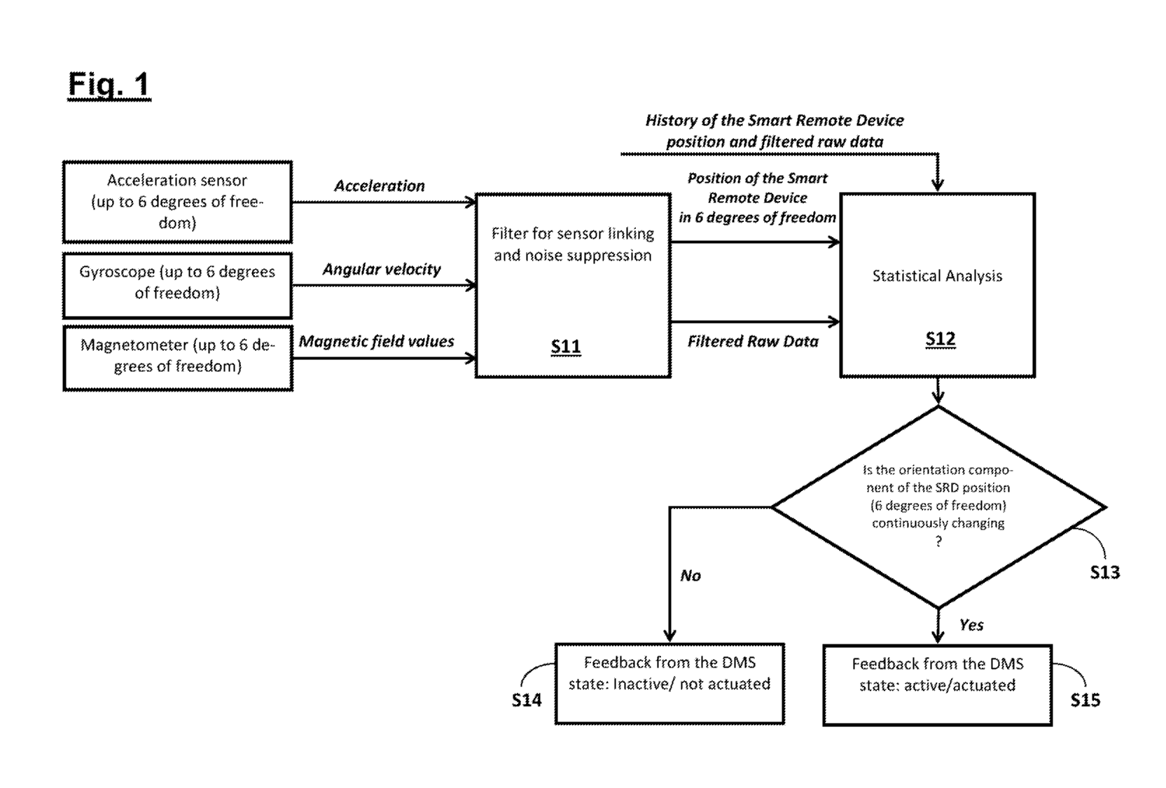

Furthermore, the operation of a device in accordance with the disclosure is described in different operating modes and in relation to the schematic diagrams of FIG. 1 to FIG. 3.

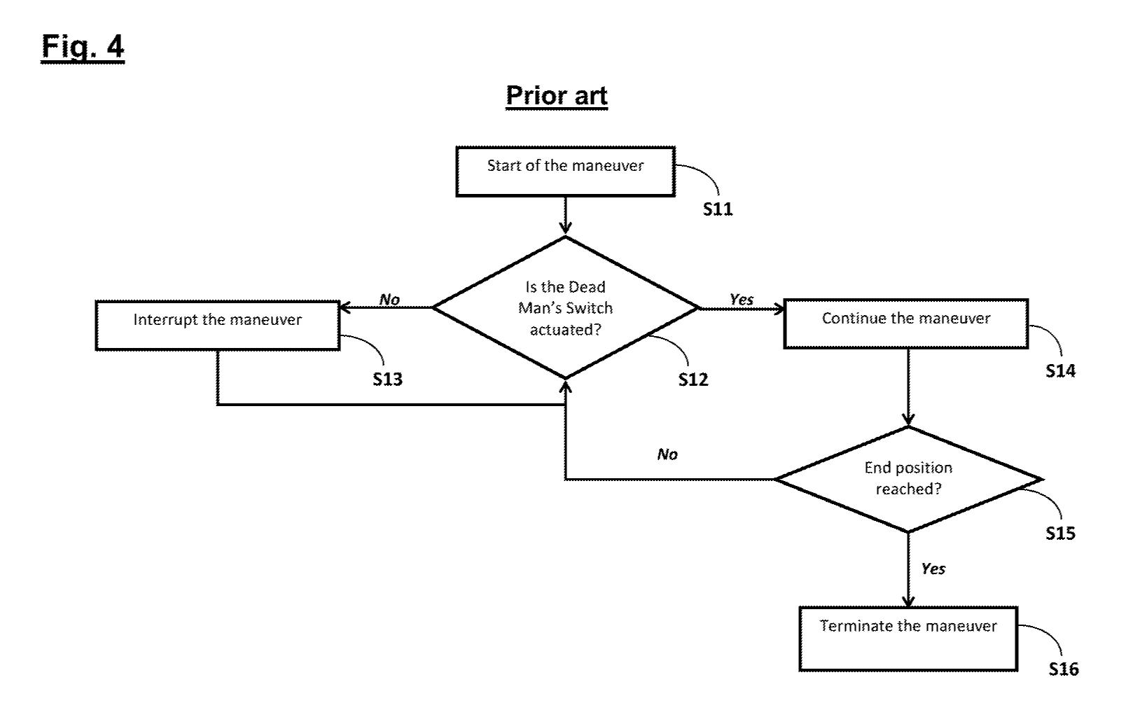

The disclosure is based on the principle of a dead man's switch that is known and already explained with reference to FIG. 4, in which the non-actuation of the dead man's switch leads to the immediate interruption of the respective remote-controlled maneuver.

In accordance with the disclosure, a remote-controlled device or operator control unit (SRD=“Smart Remote Device”) that is fitted with inertial sensors (acceleration sensors, gyroscopes and/or magnetometers) is used to implement such a dead man's switch. The sensor data that are provided by said inertial sensors make it possible to implement a dead man's switch for use in a remote-controlled maneuvering procedure or parking maneuver, as is further explained hereinunder:

Furthermore, it is assumed that an operator who monitors a maneuvering procedure, such as, for example, a maneuver entering or exiting a parking space or garage, holds the operator control unit and must handle or move this operator control unit in a defined manner in order to maintain the maneuver (in other words to avoid immediately aborting this maneuver).

In accordance with the operating mode of FIG. 1 (“mode A”), a continuous change in spatial orientation of the operator control unit is required in order to continue performing the maneuver, and the operator must, therefore, make, for example, a continuous rotating movement of the operator control unit so as to continue the maneuver.

A corresponding query as to whether a continuous change is occurring in the spatial orientation of the operator control unit is performed in accordance with FIG. 1 in a step S13, with the change in the spatial orientation being itself accordingly determined on the basis of acceleration values, angular velocity values and magnetic field values that are provided by the inertial sensors. The values are initially subjected, in accordance with FIG. 1, to a filtering procedure so as to link the sensors and to suppress noise (step S11) and a statistical analysis (step S12) while taking into account a history of a spatial position of the operator control unit.

If a continuous change in the spatial orientation of the operator control unit is positively identified in step S13, corresponding feedback is provided in accordance with step S15 (with the result that the dead man's switch that is implemented in this manner is perceived as being “actuated” or “active”). Otherwise—i.e. if a continuous change in the spatial orientation of the operator control unit is not detected—corresponding feedback is likewise provided so that the dead man's switch that is implemented in accordance with the disclosure is then perceived as being “not actuated” or “inactive” (step S14). In the case just mentioned, the maneuver is immediately interrupted in a similar manner to the principle already described with reference to FIG. 4.

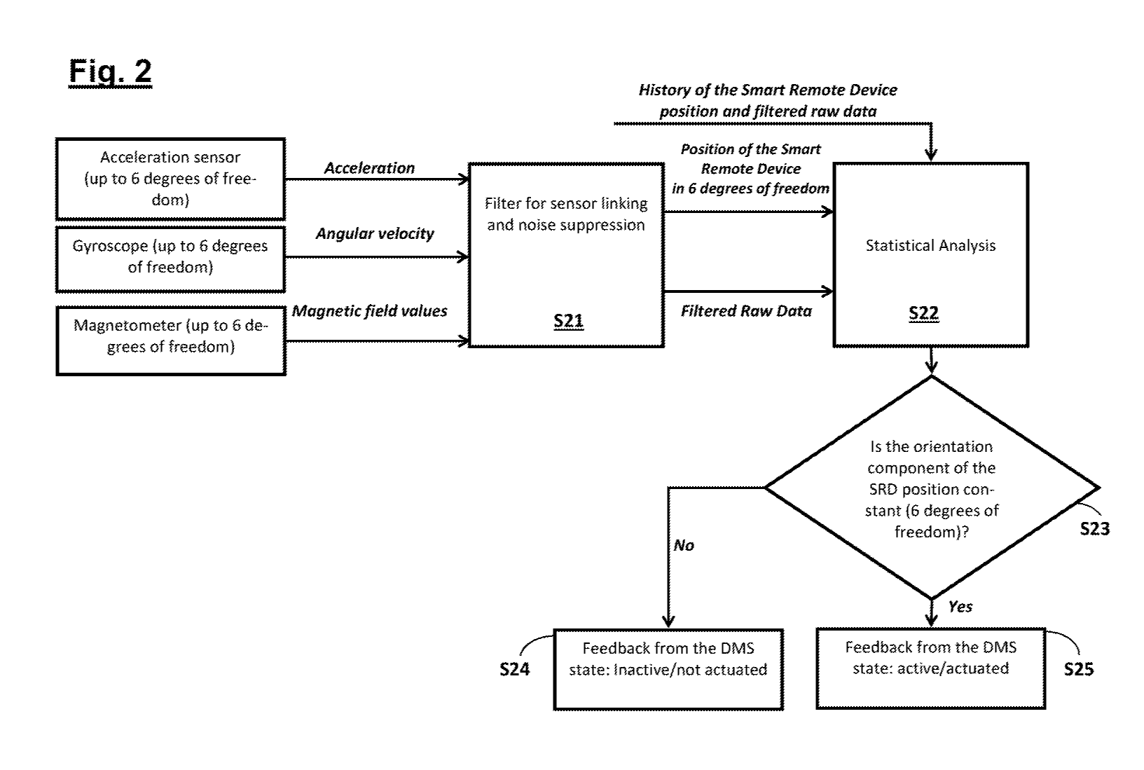

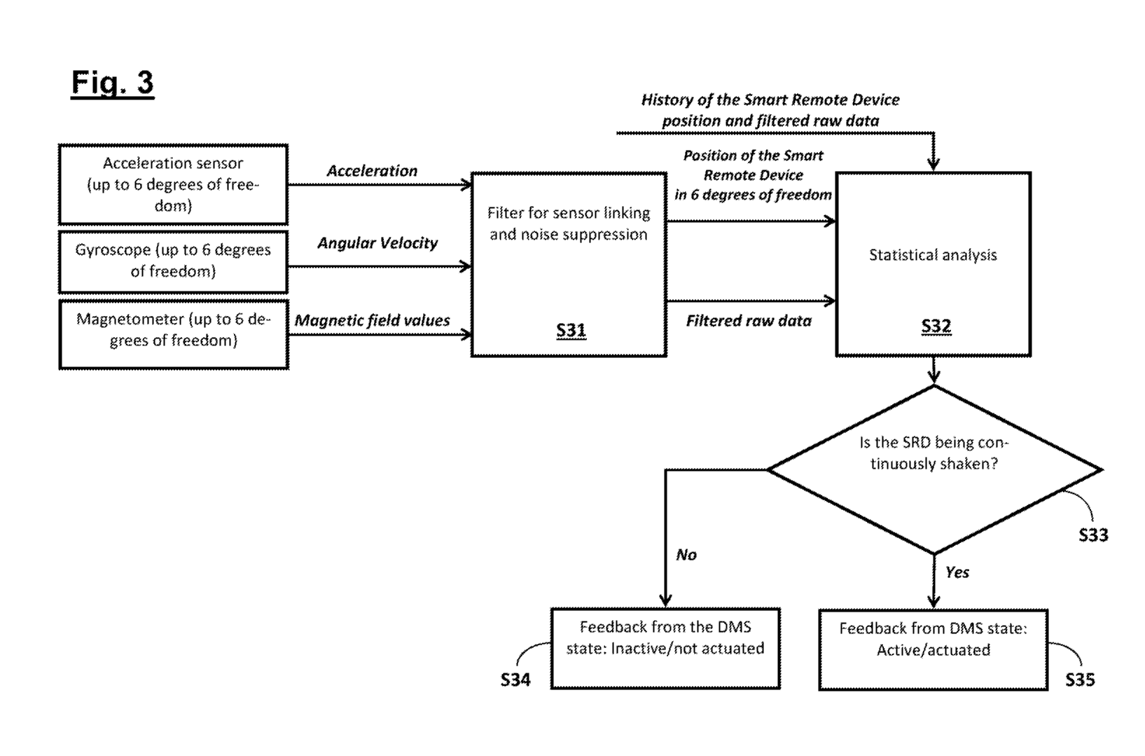

FIG. 2 and FIG. 3 illustrate diagrams similar to FIG. 1 to explain further operating modes, with steps that are similar or essentially functionally identical to FIG. 1 being referred to with reference numerals increased by “10” or “20”.

An operating mode (“mode B”) that is illustrated schematically in FIG. 2 differs from that in FIG. 1 only in that, in this case (to some extent the opposite of FIG. 1), a constant spatial orientation of the operator control unit is perceived as a requirement to continue the maneuver (corresponding to an “active” or “actuated” state of a dead man's switch).

An operating mode (“mode C”) that is illustrated schematically in FIG. 3 differs from that in FIG. 1 or FIG. 2 in that this case a continuous shaking movement, or wobbling movement, of the operator control unit is perceived as a requirement to continue the maneuver (corresponding to an “active” or “actuated” state of a dead man's switch).

The above-described alternatives, or operating modes, are implemented by the operator control unit, with inertial sensor data being required as an input signal and a “keep alive”—signal (i.e. a prompt to maintain the operation) is provided as an output signal. As long as a predetermined handling (that is to say, for example, the shaking movement) is performed (corresponding to a continuous actuation of a dead man's switch), the “keep alive”—signal is continuously transmitted to the vehicle that is performing the maneuvering procedure with the result that the driver must consciously confirm that they wish to continue the maneuvering procedure, or parking maneuver. As soon as the predetermined handling (that is to say, for example, the shaking movement) stops (corresponding to the release of a dead man's switch), transmission of the “keep alive” signal is immediately stopped in order to indicate that the maneuvering procedure, or the parking maneuver, is to be interrupted.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A device that assists a maneuvering procedure of a motor vehicle, comprising:
a plurality of inertial sensors that generate sensor signals indicative of a spatial orientation of an operator control unit, wherein the operator control unit is configured to, in response to a predetermined actuation of the operator control unit performed by an operator monitoring the maneuvering procedure and a change in the spatial orientation of the operator control unit, bring about a continuation of the maneuvering procedure using the plurality of inertial sensors on a basis of the sensor signals.

2. The device as claimed in claim 1, wherein said inertial sensors determine a position of the operator control unit in six degrees of freedom.

3. The device as claimed in claim 1, wherein the plurality of inertial sensors includes at least one acceleration sensor, at least one gyroscope and at least one magnetometer.

4. The device as claimed in claim 1, wherein, in at least one operating mode, a continuation of the maneuvering procedure is brought about only as long as a continuous change in a spatial orientation of the operator control unit is detected.

5. The device as claimed in claim 1, wherein in at least one operating mode, a continuation of the maneuvering procedure is brought about only as long as a spatial orientation of the operator control unit remains constant.

6. The device as claimed in claim 1, wherein, in at least one operating mode, a continuation of the maneuvering procedure is brought about only as long as a continuous shaking movement of the operator control unit is detected.

7. A parking maneuver assist system comprising:
a control unit configured to, in response to a predetermined actuation of a maneuvering procedure in at least one operating mode, continue the maneuvering procedure using a plurality of inertial sensors only if a spatial orientation of the control unit remains constant, the spatial orientation of the control unit being detected by the plurality of inertial sensors.

8. The parking maneuver assist system as claimed in claim 7, wherein the plurality of inertial sensors includes an accelerometer, a gyroscope and a magnetometer.

9. The parking maneuver assist system as claimed in claim 7, wherein the control unit is further configured to, in response to a predetermined actuation of a maneuvering procedure in at least another operating mode, continue the maneuvering procedure using a plurality of inertial sensors only if a continuous shaking movement of the control unit is detected via the inertial sensors, wherein the inertial sensors include an acceleration sensor, a gyroscope, or a magnetometer.

10. The parking maneuver assist system as claimed in claim 7, wherein the control unit is further configured to, in response to a predetermined actuation of a maneuvering procedure in at least another operating mode, continue the maneuvering procedure using a plurality of inertial sensors only if a continuous change in a spatial orientation of the control unit is detected via the inertial sensors, wherein the inertial sensors include an acceleration sensor, a gyroscope, or a magnetometer.

11. The parking maneuver assist system as claimed in claim 7, wherein the inertial sensors are configured to detect a spatial orientation of the control unit.

12. The parking maneuver assist system as claimed in claim 11, wherein a continuation of the maneuvering procedure is controlled based on a change in the spatial orientation of the control unit during at least another operating mode.

13. The parking maneuver assist system as claimed in claim 7, wherein the plurality of inertial sensors is configured to detect a position of the control unit in six degrees of freedom.

14. A vehicle comprising:
a plurality of inertial sensors including an acceleration sensor, a gyroscope or a magnetometer; and
a control unit configured to, in response to a predetermined actuation, via an operator, of a parking maneuver device in a first operating mode, continue a maneuvering procedure using the plurality of inertial sensors only if a spatial orientation of the control unit, detected via the inertial sensors, remains constant in the first operating mode.

15. The vehicle as claimed in claim 14, wherein the control unit is further configured to, in a second operating mode, continue the maneuvering procedure only if a continuous change in a spatial orientation of the control unit is detected using the inertial sensors.

16. The vehicle as claimed in claim 14, wherein the control unit is further configured to, in a third operating mode, continue the maneuvering procedure only if a continuous shaking movement of the control unit is detected.

17. The vehicle as claimed in claim 14, wherein the control unit is further configured to control the maneuvering procedure based on a change in the spatial orientation of the control unit.

18. The vehicle as claimed in claim 14, wherein the plurality of inertial sensors is configured to detect a position of the control unit in six degrees of freedom.
